(19) United States
(12) Patent Application Publication
(10) Pub. No.: US 2002/0033779 A1
(43) Pub. Date: Mar. 21, 2002

(54) System and method for information distribution for an information display terminal and a source server

(75) Inventors: Masaaki Nakai, Osaka-Shi (JP); Keizou Ochi, Takatsuki-Shi (JP); Yutaka Tsurumoto, Kobe-Shi (JP); Kazuaki Okumura, Ikeda-Shi (JP); Hideo Hotomi, Nishinomiya-Shi (JP); Katsuhiko Asai, Takatsuki-Shi (JP)

Correspondence Address: SIDLEY AUSTIN BROWN & WOOD, 717 NORTH HARWOOD, SUITE 3400, DALLAS, TX, 75201, US

(73) Assignee: MINOLTA CO., LTD.,

(21) Appl. No.: 09/808,588

(22) Filed: Mar. 14, 2001

(30) Foreign Application Priority Data
Mar. 30, 2000 (JP) 2000-0095810
Mar. 30, 2000 (JP) 2000-0095811
Mar. 31, 2000 (JP) 2000-0099827
Jun. 30, 2000 (JP) 2000-0200290
Jun. 30, 2000 (JP) 2000-0200291

(51) Int. Cl. G09G 5/00

(52) U.S. Cl. 345/2.1

(57) ABSTRACT

An electronic information distribution system that includes at least one server and a user display terminal. The server and the display terminal cooperate in the transfer, the management, and the display of display information, such management techniques including: efficient storage of display information, allocation of display information for initial and subsequent presentations, and distribution of display information from the at least one server.

### FIELD OF THE INVENTION

The present invention relates to a system for distributing electronic information, and in particular, to a system that includes a display device to display certain electronic image information periodically distributed from a source.

### BACKGROUND OF THE INVENTION

In recent years systems have been proposed for electronically distributing electronic publications such as electronic newspapers and electronic magazines over communication lines, such as the Internet. The information proposed for such systems includes various articles and images on a plurality of pages and to review the articles of greatest interest requires searching for and displaying articles one by one. When considering sequential electronic distribution of new article information on the reception side, the memory capacity at the reception side must be increased, but since memory capacity is generally limited, previously stored information must be suitably deleted. However, deletion by selecting article information one by one is complex, and there is concern old publications and new publications may become undesirably mixed. For at least these reasons, conventional systems are generally considered troublesome.

Further, conventional systems for electronically distributing electronic newspaper and electronic magazine have been proposed, for example, for transmitting data over the Internet, wherein part of the information may be cut out and saved (i.e., “scrapbooked”) ) at a receiving end (e.g., relay server, display terminal). In this case the scrapbook information accumulates on the relay server or display terminal and greatly diminishes the memory region of the memory medium so as to disadvantageously impede the saving of new scrapbook information. Moreover, there are various types of information, specifically images, videos, and voice data that greatly consumes storage capacity when saved.

Scrapbooking articles of electronic data of digitized newspaper and magazines are the concern of Japanese Laid-Open patent application Ser. No. HEI 11-259489, which discloses a system for saving scrapbook information at a “scrapbook center.” However, communication with the scrapbook center is required for each reading of scrapbook information, thus frequent reading disadvantageously (and necessarily) increases communication costs.

For conventional systems, no significant regard has been given to the importance of maintaining previously saved information. For example, information having a low access frequency and information having an old save date may be said to have a low importance for saving.

Further yet, in display devices for displaying electronic newspapers and electronic magazines and the like consider a function for indicating, or “marking-up,” a specific article displayed on a screen in order to select and/or save such specific article. This selection and saving process is referred to as “scrapbooking.”

One suitable method of selecting a displayed region is to trace, for example, text to be picked up in reverse display as achieved beforehand by a word processor or the like. However, this method requires much labor and time to pickup the text (i.e., an article), and accurately tracing the text is difficult, leading to concern of introducing error to the text position.

Japanese Laid-Open Patent Application No. HEI 9-305704 discloses a method wherein image data are read optically from a page surface such as a newspaper, magazine, or the like via an image input device and displayed on a display device. For selecting a desired article of text, the operator specifies one letter of the article to be cut, specifies the first letter and the last letter of the article, and then cuts the specified text. However, there is no function provided to emphasize or to discriminate the selected region, such that a plurality of articles cannot be simultaneously selected, which is disadvantageous from the perspective of operability.

It is acknowledged that when using a conventional browser to view textual data (e.g., an electronic newspaper) over the Internet, for example, a headline of the electronic newspaper can be selected by one touch. In particular, by positioning a cursor on a displayed headline and clicking the mouse, the headline overlaid by the cursor typically changes color and is displayed.

The selection of a headline using a mouse in this way, however, has disadvantages in that the selection to display and save detailed content corresponding to the headline releases the headline selection after the reading and saving of the detailed content ends. A further disadvantage is a cancellation of the selection occurs when the cursor is moved.

### SUMMARY OF THE INVENTION

An object of the present invention is to provide a system, which can include a display device, a relay server, a display system, data reception method, and electronic publication display device capable of sequentially receiving information and managing new information without impedance even when the capacity of respective memory devices is small.

Another object of the present invention is to provide a display device and display method capable of immediately alerting a user to received information and allowing the user to view the articles of greatest interest immediately during reception.

Another object of the present invention is to provide an electronic article display device having excellent operability and allows easy mark-up of a desired article.

Another object of the present invention is to provide an electronic article data structure suitable for marking-up and for saving a desired article.

Another object of the present invention is to provide an information terminal and communication system which avoids impeding the saving of new information.

Another object of the present invention is to provide an information terminal and communication system capable of saving information in a state allowing the information content to be specified as much as possible.

Another object of the present invention is to provide an information display terminal capable of saving information efficiently.

Another object of the present invention is to provide an information display terminal capable of avoiding communicating with the host server when viewing saved information.

At least a portion of the above-stated objects are attainable by a display device of the present invention comprising a reception means for receiving information, memory means for storing information received by the reception means, processing means for releasing single units of information memory regions previously used for storage in the memory means in response to the reception of single units of information by the reception means, control means for storing the received information in the memory means, and display means for displaying new information stored on the memory means.

Single units of information are, for example, data of electronic newspapers and magazines electronically distributed in a single session and may include information such as a plurality of articles, images, and advertisements.

In the display device having this structure, when a single unit of information is received, the memory region of a single unit of information previously stored is released. Release of a memory region means a process of enabling the writing of data by deleting the stored data of the memory region or enabling overwrite by voiding stored information. Then, the received new information is stored in the memory means.

Accordingly, the memory means requires as large a capacity as possible to store multiple units of information. Since old information is replaced by new information, there is no impedance to managing new information. Moreover, information for deletion need not be selected one by one, so new information is not mixed with old information. Memory capacity overflow due to excess electronic distribution is prevented.

In the display device of the present invention, the control means may initially display to the display means specific topics from information newly stored on the memory means. This is advantageous for the user since specific topics the user wants to view are initially displayed.

The relay server of the present invention is a relay server for relaying information between a host device and the terminal, and comprises a reception means of receiving information, memory means for storing information received by the reception means, processing means for releasing single units of information memory regions previously used for storage in the memory means in response to the reception of single units of information by the reception means, and control means for storing the received information in the memory means.

In the relay server of this construction, the operational effectiveness is identical to that of the display device.

The display system of a present invention comprises a relay server and display terminal for receiving information from the relay server, wherein at least information of specific topics determined beforehand are received from the relay server and displayed on the display terminal.

In the display system having this structure, since specific topics determined beforehand are received from the relay server and displayed on the display terminal, the user of the display terminal is quickly able to see the information of specific topics. Of course, the display terminal is also capable of receiving information including other topics.

In this display system, information of a plurality of units may be stored on the relay server. The memory capacity of the display terminal is used at a minimum limit.

At least one data reception method of the present invention comprises a step of receiving information by a reception means and a step of storing information received by the reception means after releasing information regions of a single unit of previously stored information in the memory means in response to the reception of a single unit of information by the reception means.

In the data reception method having this structure, when a single unit of information is received, the memory region of a single unit of previously stored information is released, and the received information is stored, such that the capacity of the memory means need not be as large a capacity as possible for storing the a plurality of units of information, and since old information is replaced by new information, there is no impedance to managing new information. Moreover, there is no need to select information for deletion one by one, and new information is not mixed with old information. Memory capacity overflow due to excess electronic distribution is thus prevented.

The electronic publication display device of the present invention comprises a reception means of receiving electronic publication information, memory means for storing received electronic publication information, display means for displaying stored electronic publication information, and control means for storing new electronic publication information in the memory means after releasing regions storing old information in response to reception of new publication information.

Since the electronic publication display device having this structure replaces old information by storing new information, little of the memory capacity of the memory means is used, and thus there is no impedance to managing new publication information as it is unnecessary to select deletion information. Old information is not mixed with new information. Memory capacity overflow due to excess electronic distribution is prevented.

At least a portion of these above-stated objects are attained by a display device of the present invention comprising a reception means for receiving information of a plurality of pages, and a control means for displaying specific information of received information on the display means in response to the reception of information from the reception means.

In the display device of the present invention, specific information is, for example, information of a particular page specified by page number and information of a particular of page specified by information classification. The received information includes identification information for identifying specific information, and this type of identification information is appended to the article information on the electronic distribution side. Furthermore, a menu screen generated based on received information is displayed as specific information.

In the display device of the present invention having this structure, when information is received, the specific information is displayed first. Accordingly, a user recognizes the reception of information itself by viewing the specific information, and also views the specific information quickly, which is advantageous.

It is desirable that the display device further comprises a specification means for specifying specific information. Auser may also optionally modify the specific information using the specification means. Electronically distributed information also may include priority display information appended to the identification information for identifying the priority display of specific information.

The display means included in the display device desirably comprises a display medium having memory characteristics. If a display medium has memory characteristics, the display is maintained even when a current flow is stopped to the display means after the display has been updated, thereby conserving energy.

In the display device of the present invention, the control means may display at least one of any of the following: electronic distribution date, distribution time, and publication name information specifying the electronic publication together with the specific information. If the distribution date and time, and publication name are known, it can be readily understood whether or not the information is the most recently distributed information.

At least one display method of the present invention comprises a step of receiving information of a plurality of pages by a reception means, and a step of displaying specific information from the received information on a display means when information is received by the reception means.

According to this display method, since the specific information is displayed first when information is received, the user recognizes the reception of information itself by viewing the specific information, and also views the specific information quickly, which is advantageous.

At least certain of the objects are attained by another aspect of an electronic article display device capable of displaying an electronic article, wherein a range may be specified in article units in an article at least part of which is displayed, and wherein other operations may be performed in the specified state.

In accordance with another aspect of the present invention of an electronic article display device capable of displaying an electronic article, a range in article units can be specified in an article at least part of which is displayed, and wherein a plurality of articles may be specified simultaneously.

For these aspects of the present invention, a range in article units can be specified in an article at least part of which is displayed, and not only can the specification be reliably accomplished, other operations may be performed in the specified state, or a plurality of articles may be specified simultaneously, thereby markedly improving operability.

The display state of a specified region may differ from the display state of a non-specified region, for example, it may be desirable to have frame lines circumscribe a specified article region.

A specified article may be displayed on an associated display not included in the display screen, or information related to the specified article may be shown. The layout of a specified article may be changed.

Another aspect of the present invention includes a display screen capable of displaying an electronic article, a specification input means for inputting specification by an operator and generating signals corresponding to the specification, a position input means for specifying a position on a display screen by an operator and generating signals corresponding to the specified position, a control means for inputting the signals from the specification input means and the position input means, wherein the control means specifies a position specified by the position input means of an article contained in a region in article units and receives new signals from the specification input means and/or position input means by the article specification state.

For this aspect of the present invention, a range in article units can be specified in an article at least part of which is displayed, and not only can the specification be reliably accomplished, other operations may be performed in the specified state, or a plurality of articles may be specified simultaneously, thereby markedly improving operability.

The specification input means and position input means may be any of various input devices such as, for example, various operation keys provided on an operation panel, touch panel, mouse, pointing device and the like.

A first electronic data structure of the present invention includes a text data region, allocation data region of the text data, and data region representing a contour (or perimeter) of the article region when displayed.

A second electronic data structure of the invention includes a text data region, allocation data region of the text data, and link data region mutually associating article region divided and displayed at a plurality of locations.

The first and second electronic data structures include at least text data and data of lowest limit required when saving an article called allocation data of the text data, and is furthermore suitable for easy markup of a desired article by including data representing the contour of an article region when displayed or link data mutually associating article regions divided and displayed at a plurality of locations.

At least a portion of the above-stated objects are attained by an information terminal provided with a reduction means for serially reducing previously saved information stored on a memory medium from lowest priority information.

The information terminal can also be provided with a communication means for communicating with a server and a specification means for specifying serial reduction of previously saved information stored in a memory medium from lowest priority information.

In the information terminals of the present inventions, previously saved information is serially reduced from the lowest priority information. Accordingly, memory media can be used efficiently, and many kinds of information can be saved. Furthermore, since the information reduction is performed serially in steps, it is easy to specify the kind of information saved without reducing all information.

In the information terminals of the present inventions, reduction of all data of a single file need not occur when reducing previously saved information and part of the data may remain. When reducing previously saved information, the remaining part of the data desirably includes minimum limit data (e.g., a discrete article number appended to each article for specifying information).

In the information terminals of the present inventions, a file that is the target of serial reduction is specified based on specific parameters. In this case, the specific parameters may include at least any item among: access frequency to previously saved information, save date, and file size.

In the information terminals of the present inventions, previously saved information may be reduced when new information is saved to the memory medium.

The communication system of another aspect of the present invention can comprise a server, information terminal communicating with the server, and a reduction means for serially reducing previously saved information stored on the memory medium of the server or the information terminal from the lowest priority information.

In this communication system, previously saved information is serially reduced from the lowest priority information. Accordingly, memory media can be used efficiently, and many kinds of information can be saved. Furthermore, since the information reduction is performed serially in steps, it is easy to specify the kind of information saved without deleting all information.

In this communication system, reduction of all data of a single file need not occur when reducing previously saved information, and part of the data may remain. When reducing previously saved information, the remaining part of the data may include minimum limit data for specifying information.

At least a portion of the above-stated objects are attained by an information display terminal for displaying part of the information electronically distributed from a host server to a relay server, which is capable of reducing the quantity of saved information when saving information related to the displayed information on the memory medium of a relay server or the memory medium of the information display terminal.

Another aspect of the present invention is an information display terminal for displaying information electronically distributed from a host server, wherein all information electronically distributed from a host server is input to a first memory medium and part of the input information is displayed. Moreover, the quantity of saved information can be reduced when saving information related to the displayed information on a first memory medium or a second memory medium.

These aspects of the present inventions are capable of reducing the quantity of information when saving information related to displayed information in a scrapbook or the like. Accordingly, little capacity of a memory medium is consumed, and many types of information may be saved. Moreover, insofar as electronically distributed information is limited to input to a first memory medium of the relay server or the display terminal, the original information may optionally be displayed and viewed without accessing the host server.

These aspects of the present inventions desirably provide selectable levels of a quantity of saved information. For example, there may be a level for deleting image information of large data quantity, and a level for saving only minimum limit information (e.g., article number appended to each article) for specifying information. Alternatively, complete save and partial save of information within a specific unit may be selectable when saving.

The present inventions may call original information prior to quantity reduction from the host server based on the saved information of reduced quantity. Normally, detailed information may be easily retrieved as needed even though reduced quantity data are saved.

The present inventions may include information appended to the saved information by a user, e.g., mark-up information and memo information, to improve usability.

### BRIEF DESCRIPTION OF THE DRAWINGS

Referring now to the drawings in which like reference numerals and letters indicate corresponding elements throughout the several views, if applicable:

FIG. 1 schematically illustrates the structure of a first example of an electronic information distribution system using a relay server of the present invention;

FIG. 2 schematically illustrates the structure of a second example of an electronic information distribution system using a display device of the present invention as a terminal;

FIG. 3 is a block diagram of a control circuit of the display terminal of the first example;

FIG. 4 is a block diagram of a control circuit of the display terminal of the second example;

FIGS. 5A and 5B show an example of a data structure of an electronic newspaper;

FIG. 6 is a flow chart of an electronic newspaper reception process;

FIGS. 7A-7C show a mode of replacing data when receiving an electronic newspaper;

FIG. 8 shows an initial display screen for the first example of the electronic information distribution system of the present invention;

FIG. 9 is a flow chart showing an initial display modification process;

FIG. 10 is an illustration of an electronic newspaper article mark-up step; FIG. 11 shows an example of an electronic newspaper layout;

FIG. 12 shows the respective regions of articles and advertisements in the exemplary layout of FIG. 11;

FIG. 13 shows an example of a mark-up of an article in the exemplary layout of FIG. 11;

FIG. 14 shows another example of a mark-up of an article in the exemplary layout of FIG. 11;

FIG. 15 shows another example of a mark-up of an article in the exemplary layout of FIG. 11;

FIG. 16 shows another example of a mark-up of an article in the exemplary layout of FIG. 11;

FIG. 17 shows another example of a mark-up of an article in the exemplary layout of FIG. 11;

FIG. 18 is a flow chart of the main routine of the control sequence for the display device of the present invention;

FIG. 19 is a flow chart of a subroutine (mark-up process) control sequence for the display device of the present invention;

FIGS. 20A and 20B shows another example of an electronic article data structure with corresponding examples;

FIGS. 21A-21D is a chart shows another example of an electronic article data structure with corresponding examples;

FIG. 22 is a flow chart of a subroutine (save process) control sequence for the display device of the present invention;

FIG. 23 is a flow chart of a subroutine (default modification process) control sequence for the display device of the present invention; and

FIG. 24 is a flow chart showing the previously saved data reduction process) control sequence for the display device of the present invention.

### DETAILED DESCRIPTION OF THE PREFERRED EMBODIMENTS

The embodiments of the disclosed system of the present invention, which can include a display device, a relay server, a display system, a data reception method, and an electronic publication display device, is described hereinafter with reference to the accompanying drawings.

General Structure of the Electronic Information Distribution System

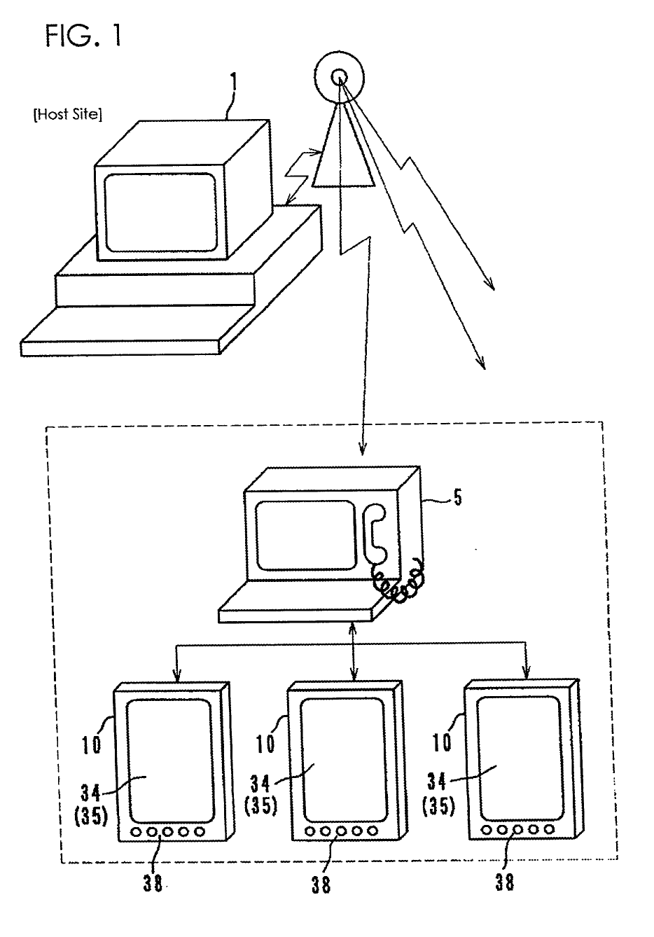

FIG. 1 shows a first example of an electronic information distribution system using an electronic information display device of the present invention as a display terminal. This system briefly comprises a host server I installed at a host site, a relay server 5 installed in a private home or building, and display terminals 10.

The relay server 5 is typically provided with a screen 6, and is capable of communicating with the host server 1 over a public telephone line and satellite, for example, electronic newspaper information from the host server 1 is periodically distributed electronically. Accordingly, the relay server 5 is provided with a memory for temporarily storing information, and a relatively large capacity memory storage device.

A plurality of display terminals 10 are distributed so as to be usable by individuals, and managed by a single relay server 5. The relay server 5 and the individual display terminals 10 are connected via a local area network (LAN) so as to allow data communication between the individual display terminals 10 and allow data communication between the display terminals 10 and the relay server 5. Communication between the relay server 5 and the terminals 10, and between the individual terminals 10 may be accomplished using a wireline LAN or a wireless LAN. The terminals 10 are removeably connected to the relay server 5, and two-way communication is possible between server and terminal when a terminal 10 is connected to the relay server 5.

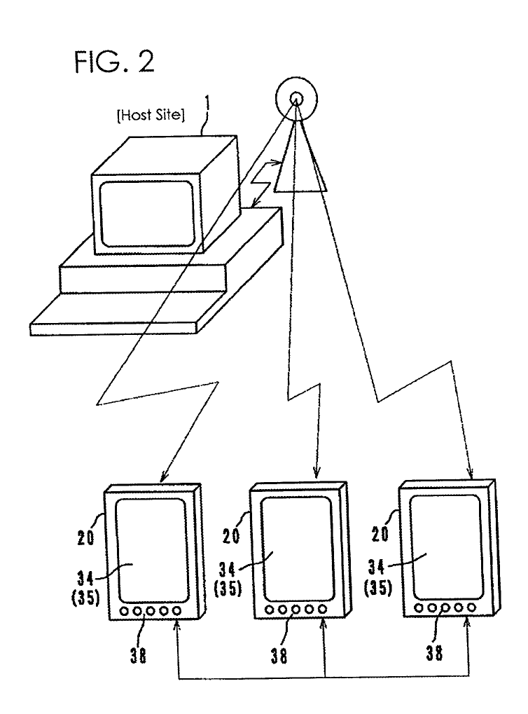

FIG. 2 shows a second example of an electronic information distribution system using the display device of the present invention as a terminal. This system omits the relay server 5, and each display terminal 20 is capable of communication with the host server 1 over a public telephone line and/or satellite, for example, electronic newspaper information from the host server 1 is periodically distributed electronically.

Accordingly, the display terminal 20 is provided with a relatively large capacity memory storage device for storing electronic informationally distributed from the host server 1, and is further provided with a relatively small capacity memory device for storing necessary information for each.

The display terminals 20 and the host server 1 are connected via a local area network (LAN) so as to not only allow data communication between the individual display terminals 20 host server 1, but also allow data communication between the display terminals 20. Communication between the individual terminals 20 may be accomplished using a wireline LAN or a wireless LAN.

Display Terminal Control Circuit

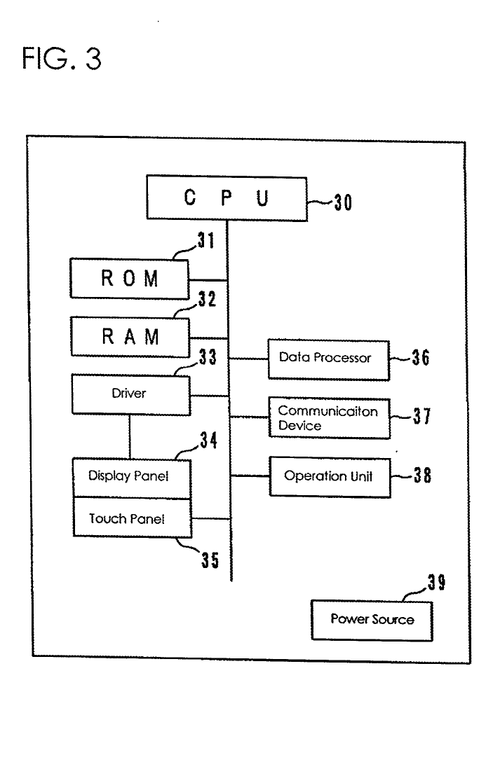

FIG. 3 shows the control circuit of the display terminal 10 used in the system of the first example. This control circuit centrally comprises a central processing unit (CPU) 30, connected to a ROM 31 for storing programs, RAM 32 for temporary storage of control parameters and the like, data processor 36, communication device 37, and operation unit 38 having various operation elements operated by a user. The CPU 30 is connected to a driver 33 for driving the display panel 34 formed of liquid crystal or the like, and as but one example, a touch panel 35 overlays the display panel 34.

In a preferred embodiment, the display panel 34 comprises a display medium having memory characteristics. That is, the display panel 34 is formed of chiral-nematic liquid crystal having a chiral element added to a nematic liquid crystal, ferrodielectric liquid crystal or the like. If a display medium having memory characteristics is used, the operation of the driver 33 is stopped after updating the display, and the display is maintained even when the current to the display panel 34 is stopped, thereby reducing energy consumption.

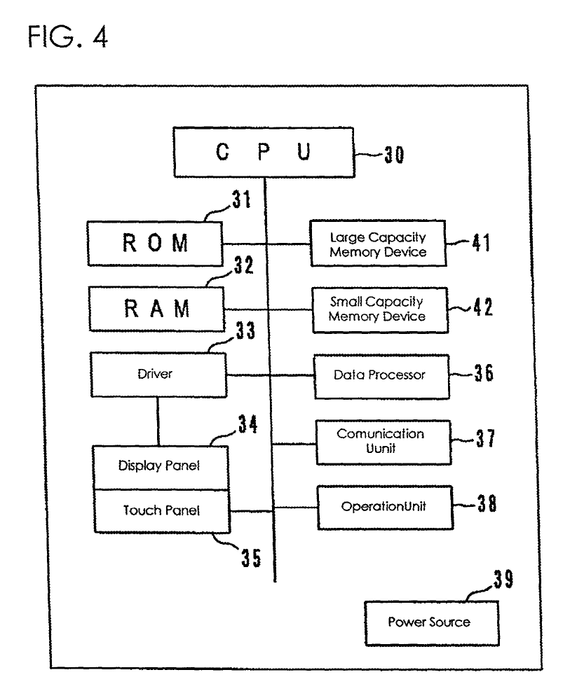

FIG. 4 shows a control circuit of the display terminal 20 used in the system of the second example. This control circuit is identical to the control circuit shown in FIG. 3, with the addition of a large capacity memory device 41 and a small capacity memory device 42. The memory devices 41 and 42 are well known memory devices such as hard disks, floppy disks, optical disks, semiconductor memory and the like, and the small capacity memory device 42 also may be used jointly by the large capacity memory device 41.

Relay Server Control Circuit

The control circuit of the relay server 5 is fundamentally identical to the control circuit of the display device 20 shown in FIG. 4. The small capacity memory device is equivalent to the memory for temporary storage of information received from the host server 1. Furthermore, the large capacity memory device is equivalent to the memory device for storing electronic newspaper information.

Data Reception and Data Structure

Data distribution and data structure are described below. The following description is fundamentally based on the system of the first example, and differing aspects regarding the second example are mentioned.

Electronic information (e.g., electronic periodicals, including electronic newspapers) is periodically distributed from the host server 1 to the relay server 5. In the second example, electronic newspaper information is electronically distributed directly to the memory device 41 of each display terminal 20. Each display terminal 10 accesses the relay server 5 necessary for the electronic newspaper information on the display panel 34.

Of note, since electronic newspaper information is electronically distributed to the relay server 5 in the first example and electronically distributed to the large capacity memory device 41 of the display terminal 20 in the second example, each display terminal 10 and 20 need not access the host server 1 each time electronic newspaper information is viewed.

When electronic newspaper information is received by the relay server 5 and display terminal 20, it may be filtered according to user preferences. For example, user preference may include only economic news, or only local news edition.

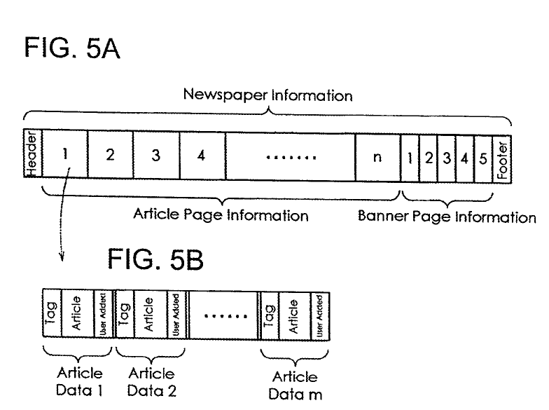

The electronic newspaper as a complete publication includes various information comprising header information, footer information, and a plurality of pages. As but one example of a data structure is shown in FIGS. 5(A) and 5(B). As shown in FIG. 5(A), one issue (one unit) of electronic newspaper information includes header information and footer information for specifying one issue of the electronic newspaper, article page information including the articles of the electronic newspaper, and banner page information corresponding to advertisements at the fold of a paper newspaper. For purposes of illustration, article page information of n pages and banner information of five pages are included in the example.

Header information includes information (e.g., initial display specifying information) for specifying the page for initial display. The initial display specifying information includes, for example, page number, article type (economy, sports, society, etc.).

As shown in FIG. 5(13), the article page information is formed by a plurality of article data. The article data has tag information including issue page, article number, and the like. Article information includes text and images and the like, and user added information includes mark-up information (discussed hereinbelow) and the like.

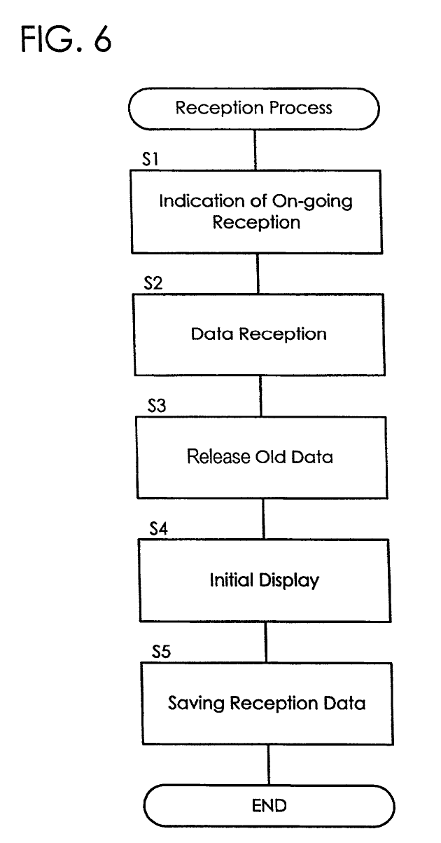

The process performed by the relay server 5 when an electronic newspaper is electronically distributed is shown in FIG. 6. First, in step S1, an indication of the on-going reception is displayed on a display such as the screen 6 or a separately provided display lamp, and in step S2, data are received and temporarily stored in memory. Then, in step S3, a memory region of old data (e.g., the previous days data) previously stored in the memory device is released. The release of the memory area may be realized by enabling data overwrite, or completely reducing/deleting old data.

Then, in step S4, from among the reception data specific topics specified beforehand are displayed on screen 6 by the operator of the display terminal 10 or relay server 5, or the distributor of the electronic newspaper. Thereafter, the reception data are saved in the memory device in step S5. Next, in a preferred step, electrical current to various parts, for example, of the display terminal 10 is turned OFF, thus the terminals enters a sleep state (e.g., a state wherein only the minimum number of circuits required to detect the next electronic distribution remain active). In this way, although the electrical current to the display is stopped by the driver 33, the display is maintained by the memory of the display. Accordingly, energy is conserved.

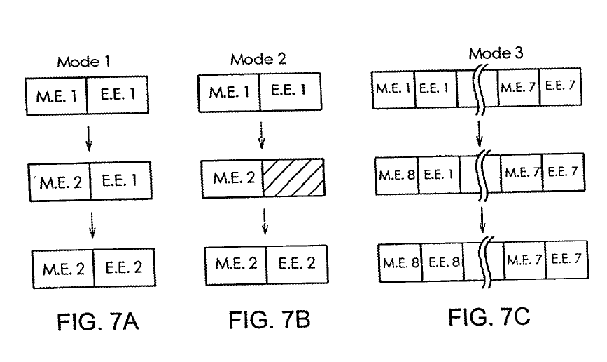

The substitution of new data for old data during electronic distribution of data is shown in the example of FIGS. 7(A)-7(C). In FIG. 7(A), mode 1 stores an evening edition 1 continuing from a morning edition 1, and the following day when the morning edition 2 is electronically distributed, the data of the morning edition 1 are released, and the data of the morning edition 2 are stored. Then, when the evening edition 2 is electronically distributed, the data of the evening edition 1 are released, and the data of the evening edition 2 are stored. Mode 1 updates data using the so-called push method, and since only the data of one day are stored, the memory device requires only a small capacity.

In reference to FIG. 7(B), mode 2 is identical to mode 1 in the aspect of storing data of one day, but when morning edition 2 is electronically distributed the day after storing the morning edition 1 and evening edition 1, the data of the morning edition 1 and the evening edition 1 are released, and the data of the morning edition 2 are stored. Then, when the evening edition 2 is electronically distributed, such data are stored. Mode 2 has the same advantage as mode 1 in that the memory device also requires a small capacity, and a further advantage in that new information is not commingled with the data of the previous day.

Lastly, referring to FIG. 7(C), mode 3 is used when the memory device has a capacity to store the data of morning editions and evening editions for a fixed period of time (e.g., for an entire week). When morning edition 8 is electronically distributed after one week, the data of the morning edition 1 are released, and the data of the morning edition 8 are stored. Similarly, when new information is electronically distributed thereafter, the oldest stored data is replaced. In mode 3, information of a fixed elapsed time period can be viewed (information of one week in this example). Moreover, the amount of stored data does not increase above a specific amount.

Initial Display

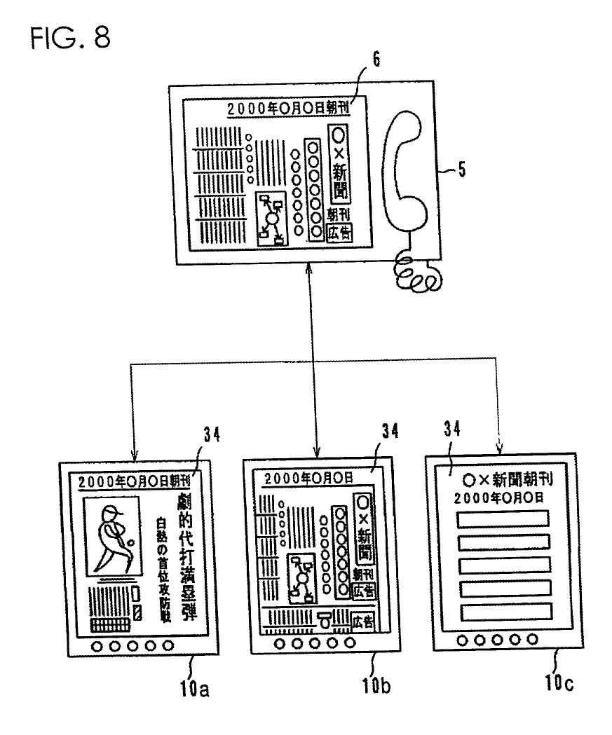

The initial display when information has been received is described below with reference to FIG. 8. First, when new electronic information is received by the relay server 5, the front page is shown in the initial display on the screen 6. In this way, electronic distribution of the new edition can be confirmed. The topics of the initial display are not limited to the front page, inasmuch as other pages or specific topics also may be displayed.

When the relay server 5 receives new electronic newspaper data, the information is redistributed to each display terminal 10. The display terminals 10 respectively function to extract specific information from the redistributed information for an initial display. The information for the initial display is set, for example, using the display terminal 10. In FIG. 8, a sports column is shown in the display terminal 10a, the front page is shown in the display terminal 10b, and an index (menu screen) listing the news articles is shown in the display terminal 10c, and these states are all initial displays.

The menu screen is generated by the control means of either the relay server 5 or the display terminal 10 or 20 based on the type of data in the electronically distributed electronic newspaper.

In any of the initial screens, the distribution time and date and newspaper edition name are displayed. Accordingly, since a user knows the distribution date and time and newspaper name, the user readily understands whether or not this information is a recent distribution, thereby eliminating the trouble of undesirably re-reading any page again.

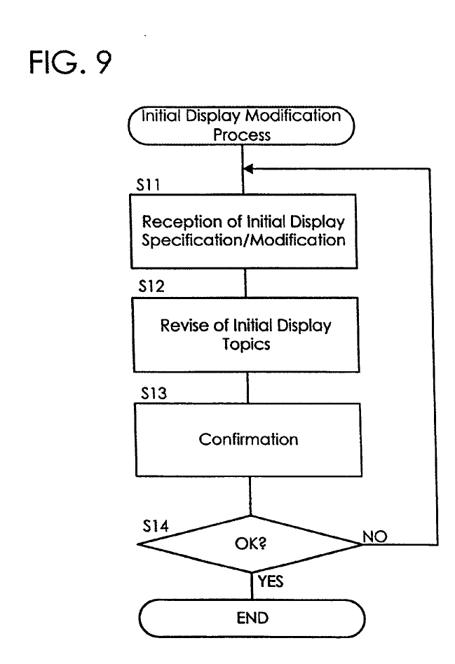

The process of a user specifying the topics of the initial display is described below with reference to FIG. 9. This process is identical for the relay server 5, each display terminal 10, and independently each display terminal 20 capable of communicating with the host server 1.

In step S11 an initial display specification or modification is received, and in step S12 the topics of the initial display are revised. The topic specification and modification by the user are accomplished using the operation keys on the relay server 5, the keys provided on the operation unit of the display terminals 10 and 20, or using the touch panel 35. Then, in step S13 the modification is confirmed, and in step S14 [OK] is confirmed, and the process ends.

Of further note, the electronic newspaper electronically distributed from the host server 1 also may include priority display information. Priority display information is emergency information, such as an extra edition, and is displayed on the relay server 5 and display terminals 10 and 20 in priority over the initial display topics. Identifiers of the priority display information are appended as header information on the electronic distribution side.

Scrapbooking

As mentioned briefly above, on display terminals 10 and 20, a user can read the displayed information and mark-up certain information on the touch panel 35 using a touch pen 45, as shown in FIG. 10. The mark-up may be accomplished by a process of circumscribing an article with a frame, reverse text, or other method when part of an article is touched by the touch pen 45. Mark-up could further be accomplished by touching the screen with a finger. Notwithstanding mark-up also may be accomplished by input via operation keys, providing a cross key, track ball, pointing device, and the like, and moving the cursor via such means to position a cursor at a desired mark-up location and clicking a specific operation key of the input device.

The marked-up article may be stored in a specific region of the memory device(s) of the relay server 5 or in the RAM 32 of the display terminal 10 in the first example, and may be stored in a specific region of the memory device 41 or in memory device 42 of each display terminal 20 in the second example.

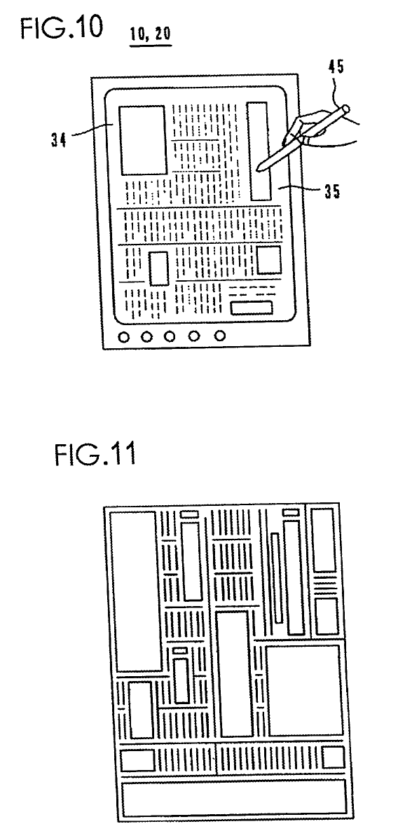

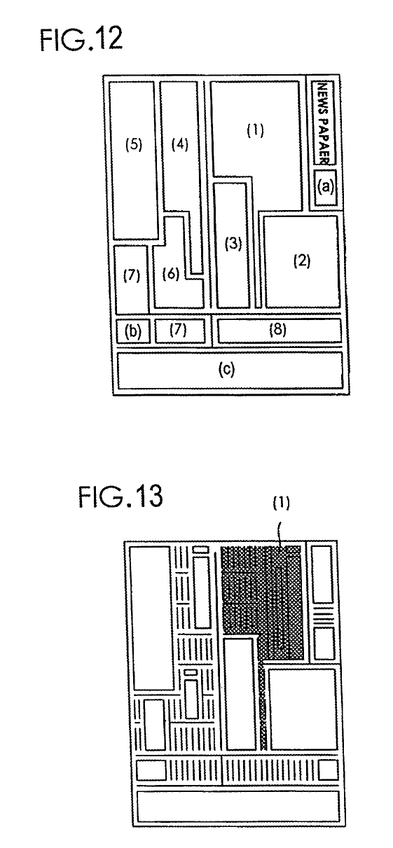

Several examples of the mark-up operation are described below. An example of a layout of an electronic newspaper displayed on display terminal 10 or display terminal 20 is shown in FIG. 11. FIG. 12 shows a layout wherein article regions are represented by regions (1)-(8), and advertisements are represented by regions (a)-(c).

FIG. 13 shows article (1) marked-up. Although the marked-up article (1) is shown as having changed color, article (1) also may be displayed circumscribed by a frame.

FIG. 14 shows another example of a marked-up article (1). In this example the display of all other areas except the marked-up article (1) is dimmed, so as to emphasize the display of article (1). Furthermore, a mosaic may be applied to the other regions, so as to emphasize the display of article (1).

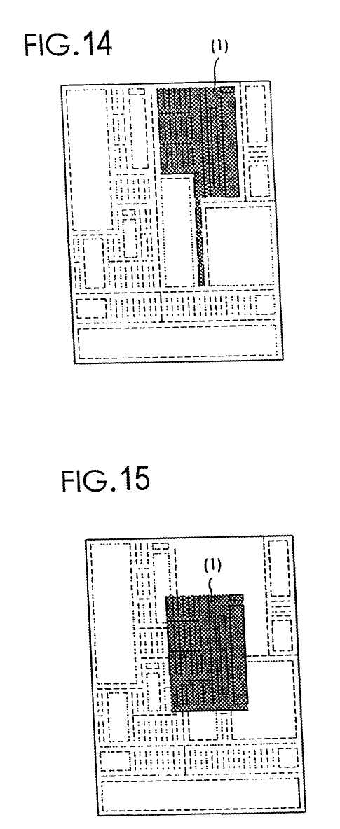

FIG. 15 shows an example wherein article (1) is again laid out after being marked-up. In the original article (1) the article location is indicated by partially extending thin lines, but the re-laid out article (1) is shown in black style for easy viewing. In this example, the display of unspecified regions other than article (1) is dimmed, for easy viewing of the specified region of article (1).

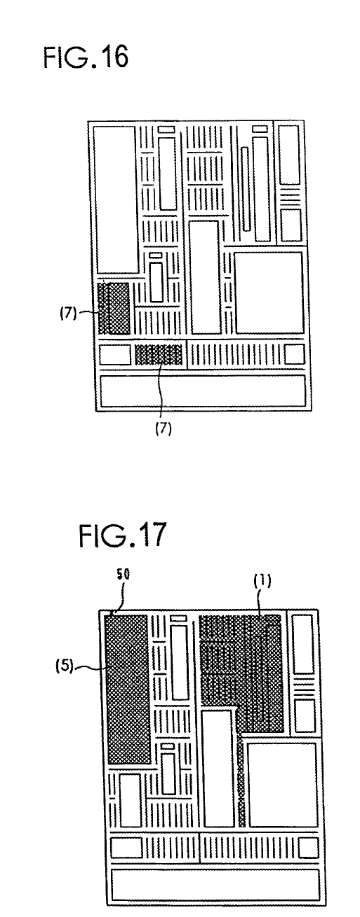

FIG. 16 shows article (7) marked-up. Although article (7) is divided into multiple regions, the entirety of the article (7) can be specified by selecting a single region of the divided article (7).

FIG. 17 shows articles (1) and (5) marked-up simultaneously. Accordingly, it is contemplated that several articles may be marked-up at the same time in this manner.

When an article is divided among several pages, and when other articles related to a certain article are divided across several pages, a message or code may be displayed representing that the article and/or the related articles are not contained on one page, or when an article related to article (5), for example, is on a different page than article (5), a mark 50 may be displayed in the vicinity of the article 5 indicating this situation. Such an example is shown in FIG. 12, whereas a mark 50 is displayed in the vicinity of the article (5) indicating that article (5) appears across several pages or that an article related to article (5) appears on a separate page.

1. Control Sequence

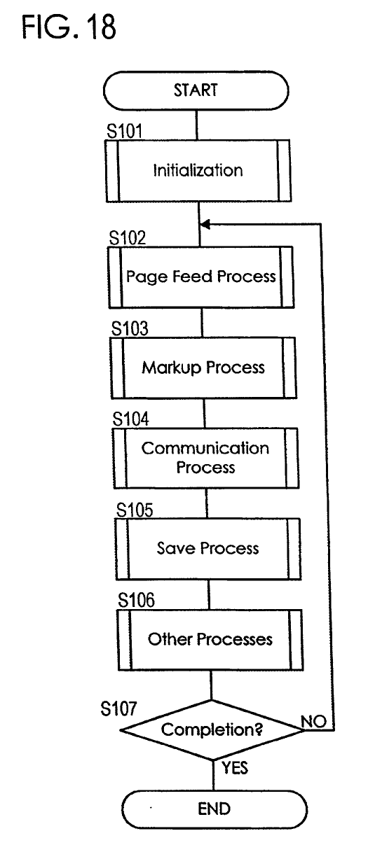

FIG. 18 shows the main routine of the control sequence executed by the CPU 30. When power is supplied and the program starts, first, each element and parameter are initialized (step S101), then the page feed process (step S102), mark-up process (step S103), communication process (step S104), save process (step S105), and other processes (step S106) are sequentially called and the required processes are executed, and the routine returns to step S2 if an interrupt process (step S107: YES) is executed.

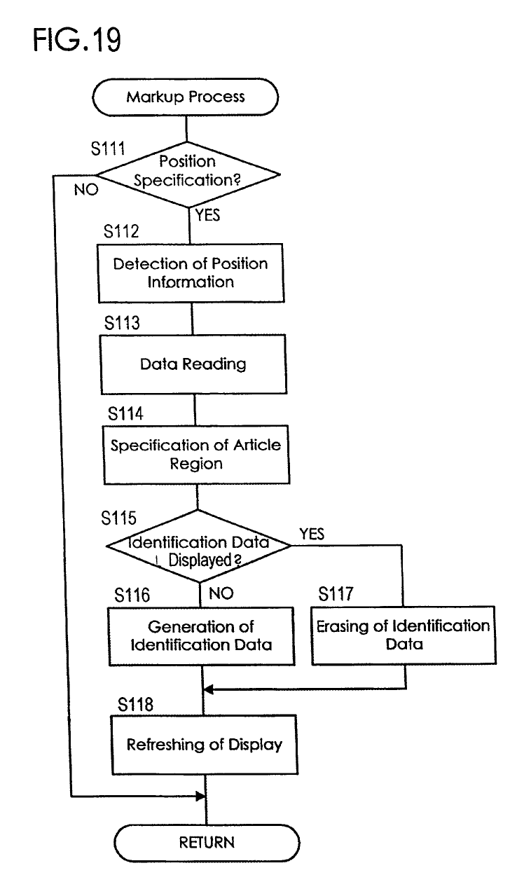

FIG. 19 shows the subroutine of the mark-up process executed in step S103. The mark-up process uses a region specification method by coordinate information from the touch panel 35 overlaid on the display panel 34.

First, when a position is specified on the touch panel 35 (step S111: YES), the position information is detected (step S112), and the data are read (step S113). Then, the indicated article region is specified (step S114), the specified article region is identified, and a determination is made as to whether or not the identification data for display are currently displayed (step S115). If not displayed, the article region identification data are generated (step S116), and the display is refreshed (step S118). If the data are already displayed, the identification data are erased (step S117), and the display is refreshed (S118). In this way the proper, accurate mark-up display can be switched when an article is specified or unselected.

After this mark-up process, the page feed process, communication process, save process (discussed hereinbelow), and other processes are executed in the marked-up state by returning to the original step. Accordingly, when feeding pages, the marked-up part is emphasized and displayed so as to be advantageously perceivable when searching marked-up articles. Furthermore, a third party other than the person creating the mark-up may be attracted by the mark-up when viewing the electronic newspaper. When executing the communication process and the save process, it is simple to retrieve and save (scrapbook) only the marked-up article. Since another mark-up process may be executed in the marked-up state, a plurality of mark-up locations are possible.

2. Data Structure Example 1

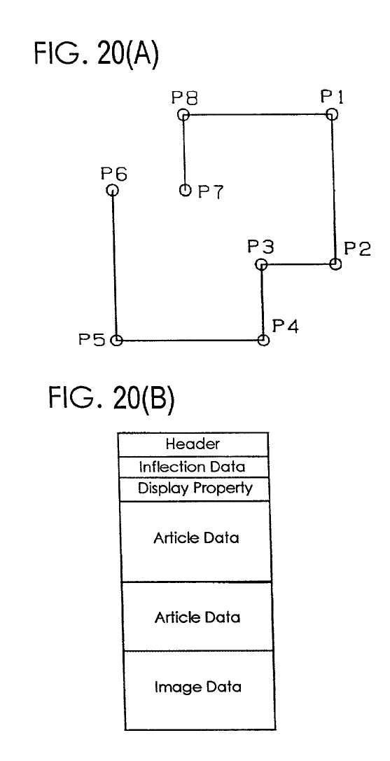

One example of an electronic article data structure is shown in FIG. 20(B). In the first example shown in FIG. 20(A), a perimeter is stipulated by coordinate data P1-P8 of salient points describing the perimeter inflections of one article (inflection data). The inflection data include standard data and differentiation data. The standard data represent an absolute position on a corresponding page, and the differentiation data represent a relative position of the standard data. The allocation position of the article on the page surface is stipulated by the inflection data.

As shown in FIG. 20(B), the data structure comprises a header, inflection data region, display property region, article data (text information) region, and image data (image information) region.

During mark-up, the mark-up object article is selected by detecting whether or not a position specified by the operator is within a region specified by the inflection data P1-P8. Accordingly, the entirety of an article may be specified simply by specifying a part within an article region, thereby providing easy mark-up. Furthermore, since the perimeter in the display state is stipulated by the inflection data, the problem of a location specified by the operator diverging from the article region desired by the operator is unlikely.

3. Data Structure Example 2

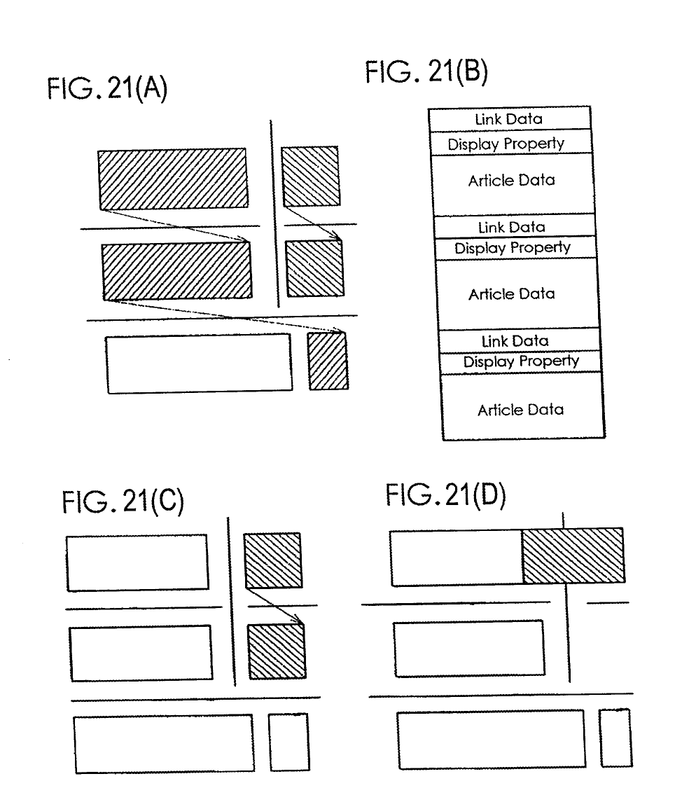

A second example of an electronic article data structure is shown in FIG. 21(B). In the illustrative example of FIG. 21(B), link information mutually associating article regions divided and displayed at a plurality of locations are included. Specifically, link data representing whether or not there is a next article region and display properties are affixed to the article region data, as shown in FIG. 21(B). Position data such as inflection data and the like, and perimeter data are desirably provided in the display property similar to the first example.

During mark-up, when the operator specifies any one of a plurality of divided article regions, all information connected by the line data is specified (see FIGS. 21(A), 21(B), and 21(D)). In this way the operator is able to specify an entire article divided in a plurality of location by simply specifying a particular article region (e.g., five regions for FIG. 21(A), two regions for FIG. 21(C), and a single region for FIG. 21(D)), thereby easily accomplishing mark-up. Furthermore, since link information mutually associates a plurality of divided article regions in the data structure of the second example, the plurality of divided article region may be joined and again laid out in an easy to view display.

When a part of a displayed page is saved to a “scrapbook” in an article unit, the information is saved to a specific region of the RAM 32 of the individual display terminal 10 or the information is saved to a specific region of the memory device 41 or to the memory device 42 for either the individual display terminal 10 and 20 or the relay server 5. When saving information, the quantity of information (i.e., “quantity level”) saved is selectable, that is, the quantity of information to be saved to the scrapbook may be reduced, then saved.

In the context of newspaper articles, this data typically includes various types of information, e.g., text information (e.g., title, heading, summary, main text and the like; each such information includes attribute information such as other information such as size information, font information, color information and the like); image information (e.g., variable contrast image, digital image, color image, and the like, attribute information such as compression method, size information, and the like); allocation information (e.g., title position, text position, image position, article position on the page); tag information (e.g., article number, newspaper name, publication date, publication page, author, photographer, article type); and also user appended information (e.g., mark-up information, memo information, type information). “Image information” may also include video information and audio information. See, supra, the discussion regarding FIGS. 5A and 5 B. All electronically distributed article information may be scrapbooked, or selectively saved. Image information and text information also may be selectively saved in part. User added mark-up information and memo information may also be saved.

A priority may be appended to the saved information in accordance with an information type. An example of a priority is shown in Table 1 below. In the example of Table 1, information is ranked A-G in accordance with data type, with priority sequentially decreasing from rank A to rank G. Numbers are added in accordance with the specific data. Moreover, priority decreases as the added numbers become larger.

TABLE 1
Information for being saved

| Data Type | Specific Data | Priority |
|---|---|---|
| Tag information | Article number | A1 |
| | Newspaper name, pub. date | A2 |
| | Page number | A3 |
| | Article position on page (approx.) | A4 |
| | Article type | A5 |
| | Other (e.g., author, photographer, | X |
| | revisions) | |
| Text information | Title | B1 |
| | Summary | B2 |
| | Main text | B3 |
| | Other (Ruby-pronunciation guide) | X |
| Image information | | C |
| Text attribute information | Size information | D1 |
| | Superscript, subscript | D2 |
| | Font information | D3 |
| | Color information | D4 |
| | Other (e.g., rule lines, decoration) | X |
| Image attribution | Compression method | E1 |
| | Other (e.g., size) | X |
| Allocation information | Title position, text position, image | F1 |
| | position | |
| | Article position on page (detail) | F2 |
| | Other | X |
| Appended information | Type information | G1 |
| | Mark-up information | G2 |
| | Memo information | G3 |
| | Other | X |

The article number is an intrinsic number appended to each article. Banner page information (i.e., advertisements) is one type of article. The priority rank “X” indicates low importance for saving and is not saved except when all information is saved. Video information and audio information include extremely large amounts of information; therefore, this form of information also can be set to low priority with a priority rank of “X.”

Priority is optionally selectable by the user of each display terminal 10 and 20. Normally, the user selected priority or the priority set when the display terminal was shipped is considered the default priority. The quantity level of information to be saved is automatically selected in accordance with this default value.

In addition to defining a quantity level of information to be newly saved, previously saved information (i.e., filed or scrapbooked information) may be subjected to data quantity reduction in accordance with specific reduction parameters in order to prevent an increase in memory usage. This reduction of previously saved information may also be given a priority for reducing information, and sequentially reduced from low importance. Table 2 shows an example of the reduction parameters.

TABLE 2
Instructions for target file reduction

| Item | Reduction parameter (n) |
|---|---|
| Access frequency | 1 |
| Save date | 2 |
| Image data size | 3 |
| Total data size | 4 |

In Table 2, the reduction parameter (n) effects a reduction when a value, for example, is greater than a prescribed number. Conditions also may be appended such that items having a value less than a specific number are reduced. For purposes of illustration, the access frequency having the reduction parameter n=[1] means terms having an access frequency less than a specific number are reduced. The save date having a reduction parameter n=[2] means items older than a specific value are reduced. Image data size and total data size respectively have reduction parameters n=[3] and [4 ], and items having a data size greater than the respective specific values are reduced. Other reduction parameters also may be added.

On the other hand, a user may call up all original information from the host server 1 from the display terminal 10 or the display terminal 20. Normally, tag information is saved with the highest priority since the information call up is based on tag information.

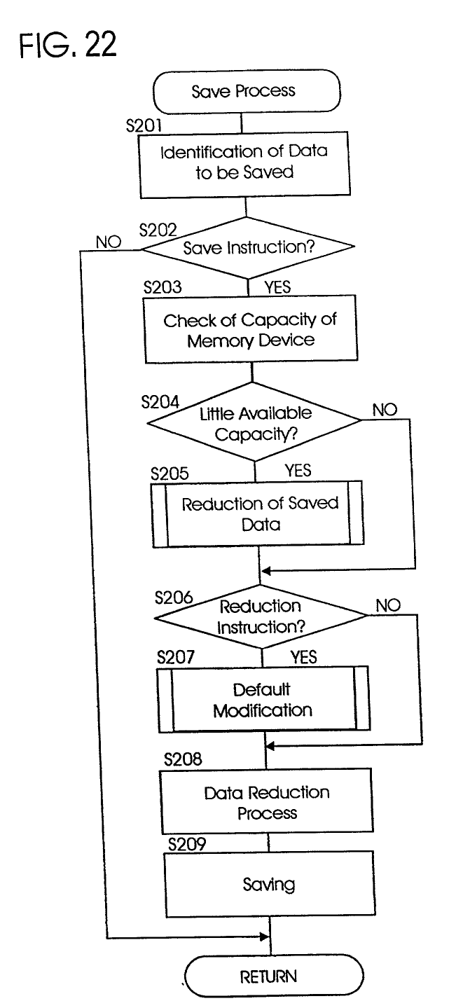

FIG. 22 shows the control sequence of a save process. Before this process, an article is selected to be saved in a scrapbook (step S201). First, after confirming the save has been specified (step 202: YES), the capacity of the memory device is checked (step S203). The memory device is the memory device 41 (or the memory device 42) within the relay server 5 in the system of the first example, and the memory device is the memory device 41 (or the memory device 42) in the display terminal 20 in the system of the second example.

If the result of the capacity check in step 203 is that there is little available capacity (step S204: YES), the previously saved data are reduced (step S205, described later).

Preferably, a user is given an opportunity to define a reduction instruction(s) for data reduction. In particular, if a user desires to modify the default specification (step S207: YES), a control sequence is executed to allow such modification. The reduction instruction(s) concerns defining a certain priority in accordance with TABLES 1 and 2.

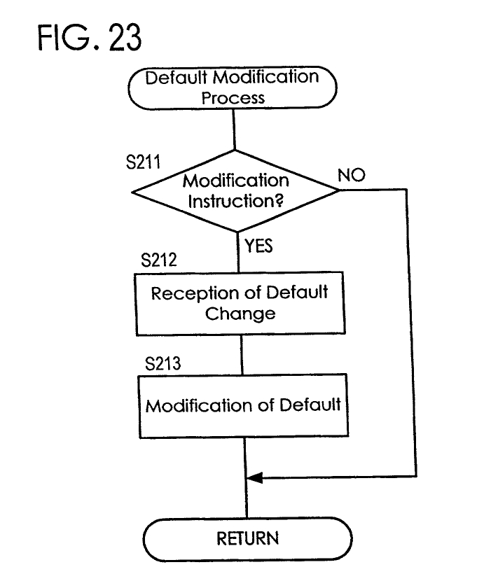

In reference to FIG. 23, when a user specifies modification of the default (step S211), the default change is received (step S212), and the default specification is modified (step S213).

Returning to FIG. 22, when there is user-specified reduction, data are reduced based on the specified reduction instruction(s), and when a user has not specified or modified the default specification, data are reduced based on the default values (step S208). The remaining data are saved (step S209).

In this way, if, for example, the reduction parameter has been set to delete all information having priority X, information other than that having priority X is saved as scrapbook information. Similarly, if the reduction parameter has been set so as to delete all information below priority C (i.e., image information), only the tag information having priority A and text information having priority B are saved as scrapbook information.

As will be understood, when the saved scrapbook information is later read and again viewed, part of the original information is omitted and displayed except for information saved without reduction. For example, files of only text without images, images without text, and only headlines may be displayed. It is possible to manage a summary of scrapbook articles by such information, and the original information can be called up from the host server based on the necessary tag information.

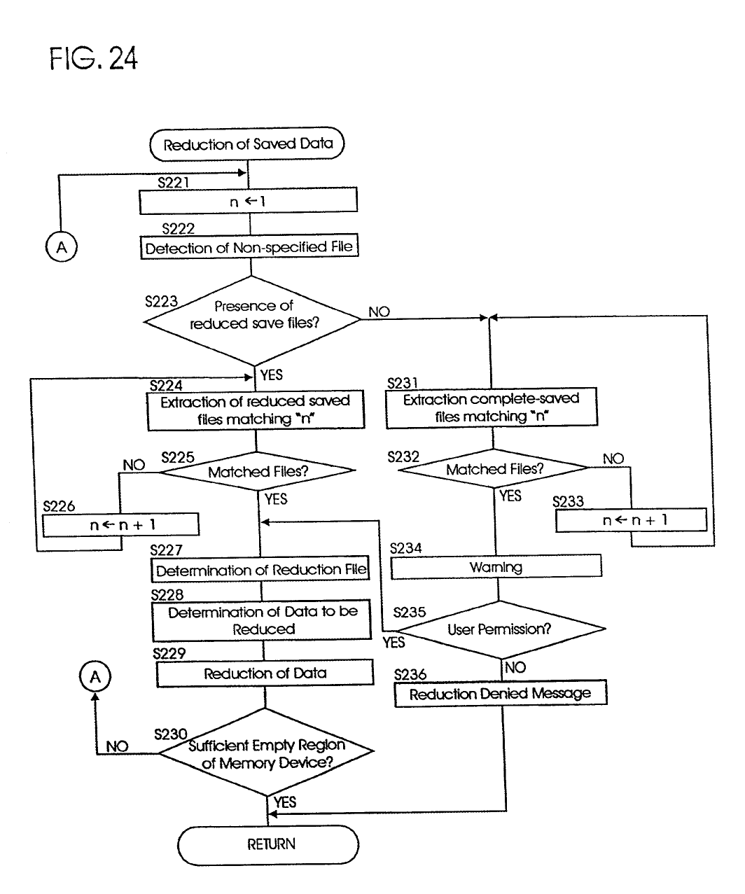

FIG. 24 shows the subroutine of the previously saved data reduction process executed in step S205.

First, the reduction parameter (n) is set to [1] (step S221). The reduction parameter is a condition specifying that previously saved files are the reduction target (see Table 2).

The reduction parameter (n) set in step S221 designates files that are “incomplete saved” files (step S222)(i.e., not “complete saved” files). When a saved file is specified as a “complete saved” file, all data are saved. Consequently, complete saved files are distinguishable from are incomplete saved files (i.e., files that have had their data reduced before saving).

For files that were subject to a data reduction before saving, (step S223: YES), if any, each file matching the reduction parameter (n) is extracted (step S224). In the case of unmatched files (step S225: NO); [1] is added to the reduction parameter n (step S226), and the subroutine returns to step S224, and files matching the next priority reduction parameter are extracted.

In step S224 (similar to step S231 described later), files matching the items shown in Table 2 are extracted. When several files are extracted, they are judged by lower reduction parameters. Files matching several reduction parameters also may be subjected to priority extraction.

If a file matches the reduction parameter (n) (step S225: YES), it is determined to be a reduction file (step S227), the data to be reduced are determined (step S228; referring to the priority of Table 1, it is desirable to save tag information having priority A), and the data are reduced (step S229).

In this way, for example, if the reduction parameter is set such that only tag information having priority A and text information having priority B remain, and all information having priority of B3 (main text) and below among the text information is deleted, only the title having priority B1 and summary having priority B2 remain after the tag information and text information having priority A. Or, if the reduction parameter is set so as to delete all information other than tag information, only the tag information remains.

Thereafter, when the saved reduced quantity information is read and again viewed, part of the original information is omitted when displayed. Summaries of the saved information can be managed from the title and summary of the information, and at least the location of the articles can be managed by specifying information from the tag information. Furthermore, the original information can be called up form the host server 1 based on the tag information as necessary.

Next a determination is made as to whether or not a sufficient empty region of the memory device can be assured (step S230), and if not assured, the subroutine returns to step S221. If sufficient space is assured, the subroutine ends.

On the other hand, when there are no reduced saved files (step S223: NO), complete saved files that match the reduction parameter n are extracted (step S231), and if there are no matching files (step S232: NO), [1] is added to the reduction parameter n (step S233), and the subroutine returns to step S231, and files matching the next priority reduction parameter are extracted.

If there are files matching the reduction parameter n (step S232: YES), a warning is generated (step S234), and user permission is sought. If user permission is granted (step S235: YES), steps S227, S228, S229, and S230 are executed. On the other hand, if user permission is not granted (step S235: NO), a reduction denied message is displayed (step S236).

Scrapbook information saved in this manner is saved in memory device 41 of the relay server 5 or in RAM 32 of the information display terminal 10 in the first example, and saved in the memory device 41 of the information display terminal 20 in the second example. Accordingly, when reading saved scrapbook information, communication with the host server 1 is avoided for each viewing. Only when it is desirable to view all information is all information fetched by accessing the host server 1 based on the tag information.

Electronic Publication Display Device

The present invention is adaptable to an electronic publication display device in addition to the display terminals 10 and 20 systematized by a communication means. Such an electronic publication display device may be identical to the display terminal 20 shown in FIG. 2 used as a stand-alone device for mainly receiving electronic magazine information. The electronic publication display device stores new electronic publication information in released regions after old information is released in the memory device in response to reception of new publication information.

The display device, relay server, display system, data reception method, and electronic publication display device of the present invention are not limited to the aforesaid embodiments, and may be variously modified insofar as such modification does not depart from the scope of the invention. Specifically, the structure of the electronic information distribution system, and the structure of the host server, relay server, and display terminal used by the system are optional. Furthermore, the electronically distributed information is not limited to newspapers, inasmuch as other periodic information such as electronic magazines, electronic catalogs and various other types of information may be used.

This disclosure is based on Application Nos. 2000-95810, 2000-95811, 2000-99827, 2000-200290, and 2000-200291 filed in Japan, the content of which is hereby incorporated by reference.

Although the present invention has been fully described by way of example with reference to the accompanying drawings, it is to be understood that various changes and modifications will be apparent to those skilled in the art. Therefore, unless such changes and modification otherwise depart from the scope of the present invention, they should be construed as being included therein.

We claim as follows:

1. An electronic display device comprising:
a display to display image information in response to a received signal;
a controller, coupled to the display, configured to deliver a signal to the display; and
an instruction input, coupled to the controller, to enable a selection of at least a portion of displayed image information, wherein the display is a display medium having a memory characteristic.

2. A device in accordance with claim 1, wherein the controller is further adapted to process selected image information.

3. A device in accordance with claim 2, further comprising a information storage device, wherein the controller is adapted to effect a save process to store selected image information to the information storage device.

4. A device in accordance with claim 2, further comprising a information storage device, wherein the controller is adapted to effect a page feed process to enable viewing of additional image information.

5. An electronic display device comprising:
a display to display image information in response to a received signal;
a controller, coupled to the display, configured to deliver a signal to the display; and
an instruction input, coupled to the controller, to enable a selection of at least a portion of displayed image information, wherein the image information is divided into a plurality of sections, and at least two of the plurality of sections are related,
wherein the controller effects a display of information on the display in accordance with such sectional divisions, and
wherein the controller is adapted to select all related sections upon selection of any section having related sections.

6. An electronic display device in accordance with claim 5, wherein the controller is further configured to alter a display state of displayed selected information relative to displayed non-selected information.

7. An electronic display device in accordance with claim 6, wherein in an altered display state, a frame circumscribes at least a portion of selected information.

8. An electronic display device in accordance with claim 6, wherein in an altered display state, a layout of at least a portion of selected information is changed.

9. An electronic display device in accordance with claim 5, wherein the controller is further configured to differ a display state between displayed selected information and displayed non-selected information.

10. An electronic display device in accordance with claim 5, when all related sections are not concurrently viewable on the display, the controller is adapted to effect a signal to the display particularly to indicate this condition.

11. An electronic display device in accordance with claim 5, wherein the instruction input is adapted to generate a signal that corresponds to a specific position within the display and relates to a section to be selected, and any generated signal is supplied to the controller.

12. An electronic display device comprising:
a display to display image information in response to a received signal;
a controller, coupled to the display, configured to deliver a signal to the display; and
a selection input mechanism, coupled to the controller, to enable a selection of at least a portion of displayed image information,
wherein the display image information is partitioned into a plurality of independent sections, and the selection input mechanism is adapted to concurrently select multiple sections, and
wherein the display is capable of concurrently displaying at least a portion of the plurality of sections.

13. An electronic display device in accordance with claim 12, wherein the controller is further configured to differ a display state between displayed selected information and displayed non-selected information.

14. An electronic display device in accordance with claim 12, wherein the controller is further configured to alter a display state of displayed selected information relative to displayed non-selected information.

15. An electronic display device in accordance with claim 14, wherein in an altered display state, a frame circumscribes at least a portion of selected information.

16. An electronic display device in accordance with claim 14, wherein in an altered display state, a layout of at least a portion of selected information is changed.

17. An electronic display device in accordance with claim 12, further comprising an associated display, wherein the associated display is adapted to display selected information.

18. An electronic display device in accordance with claim 12, wherein the instruction input is adapted to generate a signal that corresponds to a specific position within the display and relates to a section to be selected, and any generated signal is supplied to the controller.

19. An electronic display device comprising:
a display to display image information in response to a received signal; and
a controller, coupled to the display, configured to deliver a signal to the display in response to certain image data,
wherein the image data is formed of data units, each unit having a prescribed data structure consisting of a plurality of data regions, and wherein the plurality of data regions for each unit includes: a text data region; boundary data, which defines a relative boundary about an associated displayed data region; and an allocation data region, which defines at least a display position for its associated data region relative to the plurality of data regions.

20. An electronic display device comprising:
a display to display image information in response to a received signal; and
a controller, coupled to the display, configured to deliver a signal to the display in response to certain image data,
wherein the image data is formed of data units, each unit having a prescribed data structure consisting of a plurality of data regions,
wherein the plurality of data regions for each unit includes: a text data region; a linking data region, which includes data that establishes a relationship between independent, related data units; and an allocation data region, which defines at least a display position within a data unit for its associated data region relative to the plurality of data regions, and wherein a data unit relates to a single display area.

21. A method of displaying image data comprising the steps of:
receiving image data representative of an image to be displayed;
processing the received image data; and
transmitting processed image data to a display so as to effect a display of the image data,
wherein the image data is formed of data units, each unit having a prescribed data structure consisting of a plurality of data regions, and
wherein the plurality of data regions for each unit includes: a text data region; boundary data, which defines a relative boundary about an associated displayed data region; and an allocation data region, which defines at least a display position for its associated data region relative to the plurality of data regions.

22. A method of displaying image data comprising the steps of:
receiving image data representative of an image to be displayed;
processing the received image data; and
transmitting processed image data to a display so as to effect a display of the image data,
wherein the image data is formed of data units, each unit having a prescribed data structure consisting of a plurality of data regions, and
wherein the plurality of data regions for each unit includes: a text data region; a linking data region, which includes data that establishes a relationship between independent, related data units; and an allocation data region, which defines at least a display position within a data unit for its associated data region relative to the plurality of data regions.

23. An information display terminal comprising:
a memory device to store display information;
a display to display information in response to a received signal; and
a controller, coupled to the display and the memory, configured (i) to deliver a signal to the display to effect a display of the display information and (ii) to manage a quantity of display information stored in the memory,
wherein stored display information is associated with priority data, and
wherein the controller manages the quantity of display information stored in the memory based on the associated priority data of the stored display information.

24. An information display terminal in accordance with claim 23, wherein the controller is adapted to reduce an amount of display information stored in the memory, wherein the display information comprises at least one image file containing image data, and the controller is adapted to reduce a quantity of image data within each image file.

25. An information display terminal in accordance with claim 24, wherein stored image files subject to reduction maintain at least a minimum level of data to enable identification of the image file.

26. An information display terminal in accordance with claim 24, further comprising an instruction device to define a reduction criteria, and the controller reduces the quantity of image data stored in the memory through modification of related image file(s) based on a defined reduction criteria.

27. An information display terminal in accordance with claim 26, wherein the reduction criteria includes at least one attribute from the following group: access frequency, save date, and file size.

28. An information display terminal in accordance with claim 23, further comprising an input device to designate display information to be stored in the memory device and to initiate a display information storage operation, wherein the controller manages the quantity of display information stored in the memory upon initiation of a display information storage operation.

29. An information display system comprising:
a server having:
a memory device to store display information; and
a transmission device to transmit display information to a display terminal;
a display terminal having:
a memory device to store display information; and
a display to display display information; and
a controller configured to manage a quantity of stored display information,
wherein stored display information includes associated priority data, and
wherein the controller manages the quantity of display information stored in the memory device of at least one of the server and the display terminal based on defined reduction criteria and the associated priority data of the stored display information.

30. An information display terminal in accordance with claim 29, wherein the controller is adapted to reduce an amount of display information stored in the memory device of at least one of the server and the display terminal,
wherein the display information comprises at least one image file containing image data, and the controller is adapted to reduce a quantity of image data within each image file.

31. An information display terminal in accordance with claim 30, wherein stored image files subject to reduction maintain at least a minimum level of data to enable identification of the image file.

32. An information display terminal in accordance with claim 30, further comprising an instruction device to define a reduction criteria, and the controller reduces the quantity of targeted image file(s) stored in the memory through modification of such image file(s) based on a defined reduction criteria.

33. An information display terminal in accordance with claim 29, further comprising an input device to designate display information to be stored in the memory device of at least one of the server and the display terminal and to initiate a display information storage operation, wherein the controller manages the quantity of display information stored in the memory upon initiation of a display information storage operation.

34. An information terminal capable of accessing a memory medium capable of storing information, the terminal comprising:
a controller to effect a reduction of information stored on a coupled memory medium, wherein the information is formed of data units, and each data unit includes priority information, and
wherein the controller effects a reduction of stored information by serially reducing data units having a lowest relative priority.

35. An information terminal in accordance with claim 34, wherein stored information subject to reduction maintains at least a minimum level of data to enable identification of such information.

36. An information terminal in accordance with claim 34, wherein the priority information concerns at least one attribute from the following group: data unit access frequency, data unit storage date, and data unit size.

37. An information terminal in accordance with claim 34, wherein the priority information concerns at least one attribute from the following group: data unit access frequency, data unit storage date, and data unit size.

38. An information terminal in accordance with claim 34, wherein the controller is adapted to store information to the coupled memory medium, and wherein the controller operatively effects the reduction of information stored on the coupled memory medium proximate to storing information to the coupled memory medium.

39. An information terminal capable of accessing a memory medium capable of storing information and communicating with a coupled server, the terminal comprising:
a controller to effect a reduction of information stored on a coupled memory medium; and
an instructional input, coupled to the controller, to receive an instruction to reduce information stored on the coupled memory medium in accordance with a prescribed manner,
wherein the information is formed of data units, and each data unit includes priority information, and
wherein the prescribed manner requires the controller to reduce stored information by serially reducing data units having a lowest relative priority.

40. An information terminal in accordance with claim 39, wherein stored information subject to reduction maintains at least a minimum level of data to enable identification of such information.

41. An information terminal in accordance with claim 39, wherein the priority information concerns at least one attribute from the following group: data unit access frequency, data unit storage date, and data unit size.

42. An information terminal in accordance with claim 39, wherein the controller is adapted to store information to the coupled memory medium, and wherein the controller operatively effects the reduction of information stored on the coupled memory medium proximate to storing information to the coupled memory medium.

43. A communication system that includes a memory medium, the system comprising:
a relay server;
a user information terminal in communication with the relay server to display information received from the relay server; and
a controller, in communication with the relay server and the information terminal, to serially reduce information previously stored based on a lowest priority attribute,
wherein stored information is defined by a plurality of data units, and each data unit includes a priority attribute.

44. A communication system in accordance with claim 43, wherein a data unit subject to reduction maintains at least a minimum level of data to enable identification of such data unit.

45. A communication system in accordance with claim 43, wherein the priority attribute is characterized by at least one of the following group: data unit access frequency, data unit storage date, and data unit size.

46. A communication system in accordance with claim 43, further comprising a host server, in communication with the relay server, wherein the host server is adapted to periodically transmit information to the relay server, wherein the memory medium is maintained within the information terminal.

47. A communication system in accordance with claim 43, further comprising a host server, in communication with the relay server, wherein the host server is adapted to periodically transmit information to the relay server, wherein the memory medium is maintained within the relay server.

48. A communication system comprising:
a server;
a user information terminal, in communication with the relay server, having a display to display at least in part information received from the server and stored in a memory medium; and
a controller, in communication with the server and the information terminal, to manage a quantity of information stored in the memory medium in accordance with a definable criteria.

49. A communication system in accordance with claim 48, further comprising an input device to supply user-added data corresponding to information to be stored, wherein supplied user-added data is adapted to be included with such information to be stored and thus stored in the memory medium.

50. A communication system in accordance with claim 49, wherein the input device is adapted to set the definable criteria.

51. A communication system comprising:
a host server;
a relay server in communication with the host server having a first memory medium;
a user information terminal, in communication with the relay server, having a display to display at least in part information received from the relay server and stored in a second memory medium; and
a controller, in communication with the relay server and the information terminal, to manage a quantity of information stored in at least one of the first memory medium and the second memory medium in accordance with a definable criteria relative to a greater quantity of information respectively supplied from the host server and the relay server.

52. A communication system in accordance with claim 51, further comprising an input device to supply user-added data corresponding to information to be stored, wherein supplied user-added data is adapted to be included with such information to be stored and thus stored in the memory medium.

53. A communication system in accordance with claim 52, wherein the input device is adapted to set the definable criteria.

54. A display device comprising:
a reception unit for receiving information defined by a plurality of data units;
a memory for storing received information defined by a plurality of storage units, each storage unit being capable of receiving a data unit;
a controller for (i) releasing a storage unit(s) previously used for information storage in the memory in response to reception of a corresponding number of data units of information by the reception means and (ii) storing the received information in the memory; and
a display for displaying information stored in the memory.

55. A display device in accordance with claim 54, wherein the controller is adapted to assign a priority display attribute to at least one data unit.

56. A display device in accordance with claim 55, wherein the controller effects an initial display of the data unit(s) having the priority display attribute in priority over data unit(s) without the priority display attribute.

57. An intermediate server for relaying information between a host server and a display device, the intermediate server comprising:
a reception unit for receiving information defined by a plurality of data units;
a memory for storing received information defined by a plurality of storage units, each storage unit being capable of receiving a data unit;
a controller for (i) releasing a storage unit(s) previously used for information storage in the memory in response to reception of a corresponding number of data units of information by the reception means and (ii) storing the received information in the memory; and
a transmission device to forward at least a portion of information stored in the memory to the display device.

58. An intermediate server in accordance with claim 57, further comprising an input device for receiving instructions defining the portion of the information to be forwarded to the display device.

59. A data management method for a memory device having a plurality of data storage units, the method comprising the steps of:
receiving information defined by a plurality of data units; and
assessing the received plurality of data units, and releasing previously stored information from a corresponding plurality of data storage data units within the memory device to facilitate storage of the received plurality of data units.

60. A display device comprising:
a reception unit to receive information defined by a plurality of data units, wherein each data unit includes attribute data;
a display to display selected data units upon reception by the reception unit; and
a controller to select data units for display based on a definable criteria, wherein the data units subject to display have attribute data in accord with the definable criteria, wherein the attribute data concerns at least one of the group of: priority display information; subject matter data, which defines a topical nature of the corresponding data unit; and identification data, which particularly defines the corresponding data unit.

61. A display device in accordance with claim 60, wherein the controller is adapted to generate an index table, displayable on the display, wherein the index table communicates at least a portion of the data units received by the reception unit.

62. A display device in accordance with claim 60, wherein the display is a display medium having a memory characteristic.

63. A display device in accordance with claim 60, wherein the display is electrically connectable to a power source, and the controller is adapted to selectively disconnect the electrical connection between the display and the power source, wherein the memory characteristic of the display medium enables a display presentation without the electrical connection.

64. A display device in accordance with claim 60, wherein each data unit includes data corresponding to a distribution time, and the corresponding distribution time is presented when a data unit is displayed on the display.

65. A display device in accordance with claim 60, wherein each data unit includes data corresponding to a source, and the corresponding source is presented when a data unit is displayed on the display.

66. A method of displaying information comprising the steps of:
receiving information defined by a plurality of data units, wherein each data unit includes attribute data;
displaying selected data units upon reception based on a definable criteria, wherein the data units subject to display have attribute data in accord with the definable criteria,
wherein the attribute data concerns at least one of the group of: priority display information; subject matter data, which defines a topical nature of the corresponding data unit; and identification data, which particularly defines the corresponding data unit.
